(19) United States
(12) Patent Application Publication
(10) Pub. No.: US 2005/0071391 A1
(43) Pub. Date: Mar. 31, 2005

(54) High availability data replication set up using external backup and restore

(75) Inventors: Martin Fuerderer, Taufkirchen (DE); Ajay Kumar Gupta, Fremont, CA (US)

Correspondence Address: DRIGGS, LUCAS, BRUBAKER & HOGG CO., L.P.A.;DEPT. ISV, 85522 EAST AVE, MENTOR, OH, 44060, US

(73) Assignee: International Business Machines Corporation, Armonk, NY (US)

(21) Appl. No.: 10/850,781

(22) Filed: May 21, 2004

Related U.S. Application Data
(63) Continuation-in-part of application No. 10/674,149, filed on Sep. 29, 2003.

(51) Int. Cl. G06F 7/00

(52) U.S. Cl. 707/204

(57) ABSTRACT

Initial set up of replication from the data storage of a primary server to the data storage of a secondary server is achieved in a fast and efficient manner that is transparent to the database servers. This is achieved by using external utilities to backup and restore for a high availability data replication set up. Data transfer can be achieved by mirroring the database storage of the primary server to an external storage during the normal operation of the server. Then transfer to the data storage of the secondary server can be carried out without disrupting the operation of the primary server. Another alternative is to transfer files directly from the primary server database storage to the secondary. After transfer, the servers are then ready for synchronization.

### CROSS REFERENCE TO RELATED APPLICATIONS

This invention is a continuation-in-part of patent application U.S. Ser. No. 10/674,149 (Docket SVL920030078US1), filed Sep. 29, 2003, and entitled HIGH AVAILABILITY DATA REPLICATION OF SMART LARGE OBJECTS, and is related to patent application U.S. Ser. No. 10/659,628 (Docket SVL920030060US1), filed Sep. 10, 2003, and entitled HIGH AVAILABILITY DATA REPLICATION OF AN R-TREE INDEX. The subject matter of these applications is hereby incorporated by reference into the present description as fully as if they were represented herein in their entirety.

### FIELD OF THE INVENTION

This invention relates generally to the field of information processing, particularly to high availability database systems. The invention is useful in integrating other data objects stored outside a primary database with high availability backup and load-sharing database systems.

### BACKGROUND OF THE INVENTION

Computer systems are vulnerable to any number of operational failure modes, such as disk failures, as well as faults caused by external forces, such as electric power spikes or outages caused by storms, earthquakes and the like. The time and costs for replacement or repair of damaged equipment can sometimes be substantial, during which the interruption of service can be even more serious. For this reason, it is important for businesses to exercise great care to ensure the ready availability of the databases stored in their computers.

Replication of data is one of the simplest methods of guarding against delays caused by system failure. In this manner, a duplicate spare can take over if the primary data source is compromised. The replication can be used at different levels depending on the degree of security and protection that is needed.

High availability data replication (HDR) provides a hot backup secondary server that is synchronized with a primary database server. Data replication is achieved by transferring log entries of database transactions from the primary server to the secondary server, where they are replayed to provide the synchronization. In addition to providing a hot backup, the secondary server advantageously provides read-only access to the database, which permits client load to be balanced between the primary and the secondary servers.

Typically, high availability data replication requires two separate database servers to run in synchronization with one another. One such server useful for these applications is the Informix Dynamic Server (IBM IDS) sold by the IBM Corporation. The IBM IDS is a general-purpose online transaction processing (OLTP) database having such features as dynamic database-driven web site enablement, linking together of multiple IBM IDS databases, continuous availability, and rapid transactional replication. The requirement of using two servers for HDR means data will be replicated from one server (the primary) to the other server (the secondary), so that the secondary is ready to be used as a hot standby in case the primary server fails. To set up this HDR pair of servers, both servers must have the same state of data. This can only be achieved by creating an archive of the primary and restoring this archive to the secondary.

For the archive and restore to set up HDR, the conventional archive and restore methods of “On-bar” and “ontape” are used. These two utilities are part of the IBM IDS product package and their conventional methods involve active data Collection by the database and writing this to a storage device (e.g. disk files or tape devices) for the backup, and reading it from the device again for restore. For additional protection, these disks or tapes can be stored in a protective vault or off-site. For various reasons, the archival methods are rather slow, especially when the data is not intended to be used for archival purposes, but is only needed to set up HDR. On large, busy database systems, the procedure can take several hours, if not days. Also, restoring can also consume considerable time. Even with backup, these procedures can require a long time. To make matters worse, the longer the procedures take, the more time will be required for synchronization between the primary and secondary servers until the HDR pair is truly operational. Therefore, the amount of time needed for the set up procedure is critical. Finally, if archiving takes a long time, the time to restore will also be excessive.

High speed data transfer between database servers can also be achieved using a replication process that utilizes data mirroring. This involves synchronously copying blocks of data from one server to multiple disks or tapes. Updates are likewise made available by the server to both the primary and the secondary tapes or disks. The data can then be restored or re-established by copying it back to the primary server. Resynchronization provides the ability to pause a synchronous mirroring operation to create a static picture of a constantly changing data source and then resume the mirroring process later without the need to recopy the entire mirror from the beginning. It (resynchronization) can be achieved in a fraction of the time that would be required to start the copying from the beginning. These capabilities allow for data to remain accessible during events, such as daily backups, scheduled maintenance, migrations, failures of communication links or equipment, or disaster occurrences.

If a failure occurs in a chunk of data in the primary memory, the mirroring enables a read from or a write to the mirrored backup until the primary data chunk is recovered. Data can only be read from the secondary server during normal operation, but is switched to full read and write when data in the primary server is corrupted.

Instead of being a feature of the database server, mirror replication can also be carried out by an operating system, alone or in some combination with a database server replication.

### BRIEF SUMMARY OF THE INVENTION

To facilitate an understanding of the discussion of the present invention, the following list of abbreviations and their definitions is provided.
DBA—database administrator
EBR—external backup and restore
HDR—high availability data replication
IDS—IBM Informix Dynamic Server
OLTP—on line transaction processing
RAM—random access memory

An object of the present invention is to provide external backup and restore (EBR) as a new method for setting up HDR and to support this method with both utilities, “ontape” and “On-bar”. An advantage is that utilities external to the database server can be used for archiving the database data and restoring it for HDR set up. Thus, it will be possible to use the capabilities of modern storage systems to full advantage, especially on large scale database systems where the HDR set up time is particularly critical or even mission critical.

With EBR, another advantage is that it is possible to create an archive that, from the perspective of the primary database server, is logically and physically consistent, without the database server knowing about the archive methods and vice versa.

The invention relates to a database archive system, a computer readable medium embodied therein, and the method of using the same. The system includes primary and secondary servers and a replicator that copies database files between the primary server and the secondary server. The system first initiates a command to the primary server to block it to the read-only mode. The data storage files are then copied from the primary server to a destination. The primary server is then released from the block, after which a command is initiated to the secondary server to recovery mode. This is followed by a command to make the secondary server the dynamic server in a high availability data replication. If logs for logical recovery are not available from the primary server, they can be read from tape storage or disk storage. Inasmuch as the set up time is short, the unavailability of logs on the primary server is rare. After the primary server is released from the read-only block, but before a command is initiated to the secondary server to recovery mode, the primary server is instructed on its role in high availability data replication. After the secondary server completes the logical recovery to the current log position of the primary server, the primary and secondary servers synchronize their data.

### BRIEF DESCRIPTION OF THE DRAWINGS

The following drawings are presented in order to facilitate the understanding of the present invention but without limiting the scope thereof.

FIG. 1 is a flow diagram of the operation of the present invention;

FIG. 2 shows a block diagram of a primary server side of a database system that includes high availability data replication and smart large objects;

FIG. 3 shows a block diagram of a secondary server side of the database system; and

FIG. 4 is a pictorial representation of a typical medium for storing a software program for implementing the invention.

### DETAILED DESCRIPTION OF THE INVENTION

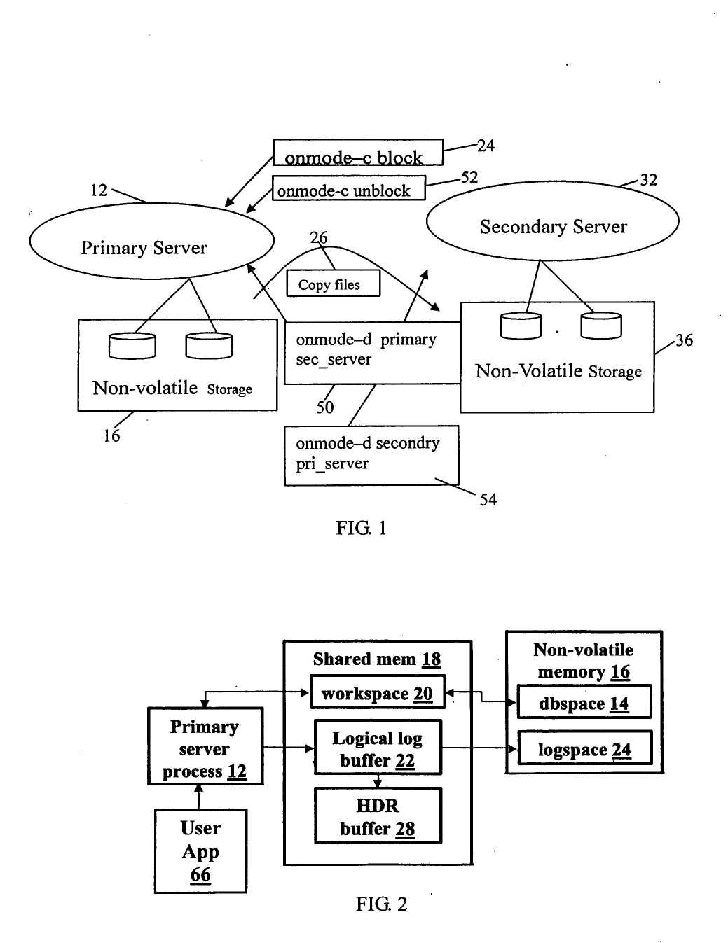

With particular reference to FIG. 1, the method of performing the replication and restore proceeds as follows. To set up an HDR pair, a full physical backup of the primary server 12 is required. Using EBR, this is done by blocking the primary to ‘read only’ mode using the command “on mode c-block” 24. The process of blocking the server for external backup allows users to stay connected and remain within transactions, while flushing all dirty (modified) buffers from the computer memory to disk to make the disk consistent with the memory. While the primary is blocked for external backup, the DBA copies the consistent data storage files (chunks) of the primary to destination machine (where the secondary server 32 will be set up). After all the chunks are copied, the primary server is released from block with the command “onmode-c unblock” 52 and users can continue with their work. The onmode command “onmode-d primary sec_server” 50 tells the primary server its role in the HDR pair. On the second (destination) machine, an “On-bar-p-e” or “ontape-p-e” command will bring up the secondary server from the copied chunks to physically recovered mode. This step will take a few seconds. Another onmode command “onmode-d secondary pri_server” 54 will make this instance of IBM IDS server the secondary server in the HDR pair. After this, both servers will ‘hand shake’ and the secondary server will start logical recovery to current log position of the primary. When log restore on the secondary server catches up with the primary, the HDR pair is operational. The following is the list of operations performed on two servers to set up the HDR pair.

| ON PRIMARY | ON SECONDARY |
|---|---|
| onmode-c block | # Block primary for backup |
| Copy chunks to secondary machine | # operation involves both machines |
| onmode-c unblock | # Unblock primary for normal |
| | operation |
| Onmode-d primary sec_server | # Let primary know its role in HDR |
| Ontape-p-e | # External restore on secondary |
| Onmode-d secondary pri_server | # Let secondary know its role |

If copying the file from the primary server to the secondary takes a long time, the DBA can make a local copy of chunks and thereby unblock the primary. Then the local copy of chunks can be copied to the secondary server without blocking the primary. It should be understood that the implementation of the present invention should provide adequate protection against file delete during data transfer and storage.

The logical and physical consistency of the archive is a prerequisite for using it to set up HDR. The external methods then can use short cuts, e.g. just for HDR set up it is not necessary to put the data on archive media (tape or disk). The external method can put it directly from primary's database storage (disks) to the secondary's database storage (disks) without intermediate write to and read from archive media. To further minimize the impact of the archive creation on the running system, especially on very large systems, special storage system technologies can be used. For example, the primary's database storage can be mirrored in the storage system during normal operation. External backup (archive) will then be done by merely splitting up the mirror in the storage system. After this action, the primary server can be unblocked to continue normal operation, so the archive procedure on the primary server can be cut to a fraction of the time (e.g. from hours using conventional archive to sub-minute for the mirror-splitting). For the external restore part, the data on the separated mirror can now be transferred in the fastest way available to the database storage of the secondary server, without any further impact on the primary server. After this, the primary and secondary servers will be ready for synchronization, i.e. the secondary will catch up with the work that has been done on the primary since finish of the archiving there.

Turning now to FIG. 2, a primary server side 10 of a database system is shown, and includes a primary server 12, which can execute on a server computer, mainframe computer, high-end personal computer, or the like. The primary server 12 maintains a primary database space 14 on a non-volatile storage medium 16, which can be a hard disk, optical disk, or other type of storage medium. The primary server 12 executes a suitable database system program, such as an IBM Informix Dynamic Server program or a DB2 database program, both available from IBM Corporation to create and maintain the primary database. The database is suitably configured as one or more tables describable as having rows and columns, in which database entries or records correspond to the rows and each database entry or record has fields corresponding to the columns. The database can be a relational database, a hierarchal database, a network database, an object relational database, or the like.

Portions of the database contents, or copies thereof, typically reside in a more rapidly accessible shared memory 18, such as a random access memory (RAM). For example, a database workspace 20 stores database records currently or recently accessed or created by database operations. The server 12 preferably executes database operations as transactions, each including one or more statements that collectively perform a database operation. A transaction optionally acquires exclusive or semi-exclusive access to rows or records read or modified by the transaction by acquiring a lock on such rows or records. A lock prevents other transactions from changing content of the locked row or record to ensure data consistency during the transaction.

A transaction generated by user application 66 can be committed, that is, made irrevocable, or can be rolled back, that is, reversed or undone, based on whether the statements of the transaction successfully executed, and optionally based on other factors such as whether other related transactions successfully executed. Rollback capability is provided in part by maintaining a transaction log that retains information on each transaction. Typically, a logical log buffer 22 maintained in the shared memory 18 receives new transaction log entries as they are generated, and the logical log buffer 22 is occasionally flushed to a log space 24 on the non-volatile storage 16 for longer term storage. In addition to enabling rollback of uncommitted transactions, the transaction log also provides a failure recovery mechanism. In the event of a database failure, the stored logs can be replayed so as to recreate lost transactions.

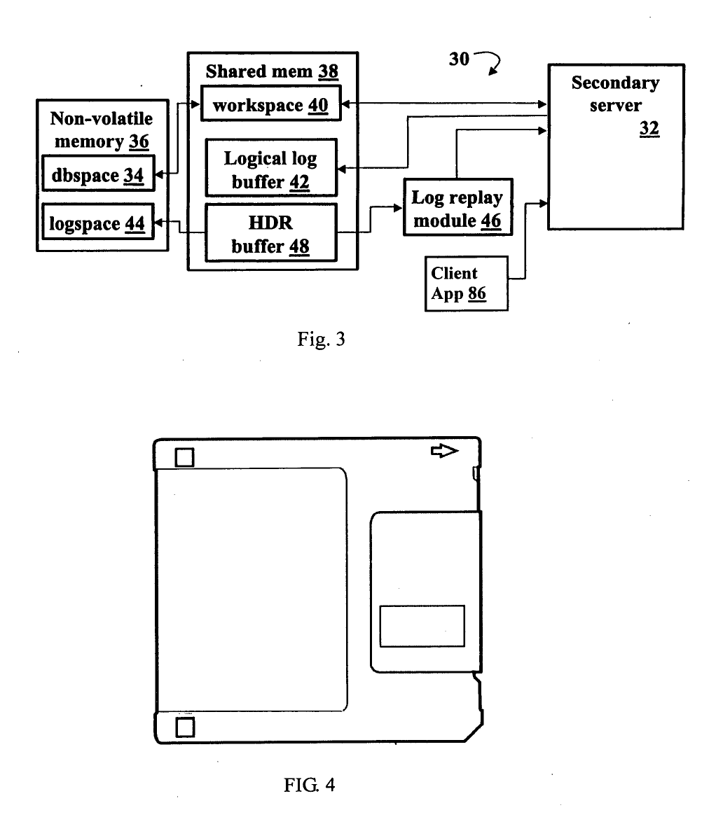

With continuing reference to FIG. 2 and with further reference to FIG. 3, to provide further reliability and robustness of the database, a high availability data replicator maintains a synchronized duplicate database on a secondary server side 30. As shown in FIG. 3, the secondary server side 30 includes a secondary server 32 that maintains a secondary database space 34 on a non-volatile storage medium 36. Client applications 86 connect to the secondary server 32 and access data in read only mode. A shared random access memory 38 contains a database workspace 40 for the secondary database, and a logical log buffer 42 holding transaction logs of transactions occurring on the primary server 10, which are occasionally transferred to a log space 44 on the non-volatile storage medium 36 for longer term storage of transaction logs. Preferably, the secondary side 30 is physically remote from the primary side 10. For example, the primary and secondary sides 10, 30 can be in different buildings, different cities, different states, or even different countries. This preferred geographical remoteness enables the database system to survive even a regional catastrophe. Although geographical remoteness is preferred, it is also contemplated to have the primary and secondary sides 10, 30 more proximately located, for example in the same building or even in the same room.

The high availability data replicator includes an HDR buffer 28 on the primary side 10, an HDR buffer 48 on the secondary side 30, and a log replay module 46 on the secondary side. The HDR buffer 28 on the primary side 10 receives copies of the data log entries from the logical log buffer 22. Contents of the data replicator buffer 28 on the primary side 10 are occasionally transferred to the HDR buffer 48 on the secondary side 30. On the secondary side 30, the log replay module 46 replays the transferred log entries stored in the replicator buffer 48 to duplicate the transactions corresponding to the transferred logs on the secondary side 30.

Preferably, the logical log buffer 22 on the primary side 10 is not flushed to the log space 24 on the non-volatile storage medium 16 until the primary side 10 receives an acknowledgment from the secondary side 30 that the log records were received from the data replicator buffer 28. This approach ensures that substantially no transactions committed on the primary side 10 are left uncommitted or partially committed on the secondary side 30 if a failure occurs. Optionally, however, contents of the logical log buffer 22 on the primary side 10 can be flushed to the log space 24 on non-volatile memory 16 after the contents are transferred to the data replicator buffer 28.

Users access the primary side 10 of the database system to perform database read and database write operations. As transactions execute on the primary side 10, transaction log entries are created and transferred by the high availability data replicator to the secondary side 30 where they are replayed to maintain synchronization of the duplicate database on the secondary side 30 with the primary database on the primary side 10. In the event of a failure of the primary side 10 (for example, a hard disk crash, a lost network connection, a substantial network delay, a catastrophic earthquake, or the like), user connections are switched over to the secondary side 30. Moreover, while the HDR pair is operational, the secondary side 30 also provides read-only access to the database to help balance user load between the primary and secondary servers 10, 30.

The database system and processing is typically implemented using one or more computer programs, each of which executes under the control of an operating system, such as OS/2, Windows, DOS, AIX, UNIX, MVS, or the like. The program causes one or more computers to perform the desired database processing, including high availability data replication and processing as described. Generally, the computer programs are tangibly embodied in one or more computer-readable devices or media. FIG. 4 shows one such computer-readable device in the form of a floppy disk 400 for containing the software implementation of the program to carry out the various steps of the process according to the present invention. Other machine readable storage mediums are fixed hard drives, optical disks, magnetic tapes, semiconductor memories, such as read-only memories (ROMs), programmable (PROMs), etc. The article containing this computer readable code is utilized by executing the code directly from the storage device, or by copying the code from one storage device to another storage device, or by transmitting the code on a network for remote execution.

The present invention can be realized in hardware, software, or a combination of the two. Any kind of computer system or other apparatus adapted for carrying out the methods described herein is suited. A typical combination of hardware and software could be a general purpose computer system that, when loaded and executed, controls the computer system such that it carries out the methods described herein. The present invention can also be embedded in a computer program product, which comprises all the features enabling the implementation of the methods described herein and which, when loaded in a computer system, is able to carry out these methods.

Computer programs and operating systems are comprised of instructions which, when read and executed by one or more computers, cause the computer or computers to perform operations to implement the database processing high availability data replication as described herein. Computer program instructions or computer program in the present context mean any expression, in any language, code (i.e., picocode instructions) or notation, of a set of instructions intended to cause a system having an information processing capability to perform a particular function, either directly or after either or both of the following occur: (a) conversion to another language, code or notation; (b) reproduction in a different material form.

While the invention has been described in combination with specific embodiments thereof, there are many alternatives, modifications, and variations that are likewise deemed to be within the scope thereof. Accordingly, the invention is intended to embrace all such alternatives, modifications and variations as fall within the spirit and scope of the appended claims.

1. A database archive system including
a) primary server;
b) a secondary server; and
c) utilities external to the servers for archiving database data and for restoring the data for high availability data replication.

2. The system according to claim 1 wherein the utilities include a program to perform the steps of:
1) initiating a command to the primary server to block to the read-only mode;
2) copying data storage files from the primary server to a destination;
3) releasing the primary server from the block;
4) initiating a command to the secondary server to recovery mode;
5) initiating a command to make a secondary server the dynamic server in a high availability data replication; and
6) starting the secondary server to the logical recovery to the current log position of the primary server.

3. The system according to claim 2 wherein, after the primary server is released from the read-only block, but before a command is initiated to the secondary server to recovery mode, the program instructs the primary server on its role in high availability data replication.

4. The system according to claim 3 wherein the program synchronizes the data in the primary and secondary servers and the secondary server completes the logical recovery to the current log position of the primary server.

5. The system according to claim 4 wherein the operation of the program is transparent to the primary server.

6. The system according to claim 5 wherein the program puts the data from the database storage of the primary server to the database storage of the secondary server.

7. The system according to claim 6 wherein both servers have disk storage, and the program transfers data from the disk of the primary server to the disk of the secondary server.

8. The system according to claim 7 wherein the data is transferred either directly or indirectly.

9. In a database including primary and secondary servers and a replicator that copies database files between the primary server and the secondary server, a method comprising the steps of archiving database data external to the servers, and restoring the data for high availability data replication.

10. The method according to claim 9 wherein the archiving utilizes the steps of:
1) initiating a command to the primary server to block to the read-only mode;
2) copying data storage files from the primary server to a destination;
3) releasing the primary server from the block;
4) initiating a command to the secondary server to recovery mode; and
5) initiating a command to make a secondary server the dynamic server in a high availability data replication.

11. The method according to claim 9 wherein the step of replication involves starting the secondary server to the logical recovery to the current log position of the primary server.

12. The method according to claim 11 wherein, after the primary server is released from the read-only block but before a command is initiated to the secondary server to recovery mode, the primary server is instructed on its role in high availability data replication.

13. The method according to claim 10 wherein the primary and secondary servers synchronize their data after the secondary server completes the logical recovery to the current log position of the primary server.

14. The method according to claim 9 wherein the archival means is transparent to the primary server.

15. The method according to claim 14 wherein the data is put from the database storage of the primary server to the database storage of the secondary server.

16. The method according to claim 15 wherein both servers have disk storage, and the data is transferred from the disk of the primary server to the disk of the secondary server.

17. The method according to claim 16 wherein the data is transferred either directly or indirectly.

18. An article of manufacture comprising a computer usable medium having a computer readable program embodied in said medium, wherein the computer readable program, when executed on a computer, causes the computer to:
1) initiate a command to the primary server to block to the read-only mode;
2) copy data storage files from the primary server to a destination;
3) release the primary server from the block;
4) initiate a command to the secondary server to recovery mode;
5) initiate a command to make an a secondary server the dynamic server in a high availability data replication; and
6) start the secondary server to the logical recovery to the current log position of the primary server.

19. The article according to claim 18 wherein, after the primary server is released from the read-only block, but before a command is initiated to the secondary server to recovery mode, the program causes the computer to instruct the primary server on its role in high availability data replication.

20. The article according to claim 19 wherein the program causes the primary and secondary servers to synchronize their data after the secondary server completes the logical recovery to the current log position of the primary server.

21. The system according to claim 18 wherein the operation of the program is transparent to the primary server.

22. The system according to claim 21 wherein the program puts the data directly from the database storage of the primary server to the database storage of the secondary server.

23. The program according to claim 22 wherein both servers have disk storage, and the program transfers data either directly or indirectly from the disk of the primary server to the disk of the secondary server.
